(19) United States
(12) Patent Application Publication
(10) Pub. No.: US 2025/0231121 A1
(43) Pub. Date: Jul. 17, 2025

(54) WAFER INSPECTION METHOD

(71) Applicant: Samsung Electronics Co., Ltd., Suwon-si (KR)

(72) Inventors: Doyoung Yoon, Suwon-si (KR); Minsu Kim, Suwon-si (KR); Sunghoon Park, Suwon-si (KR); Jongcheon Sun, Suwon-si (KR); Kwangil Shin, Suwon-si (KR); Yusin Yang, Suwon-si (KR); Suyoung Lee, Suwon-si (KR)

(21) Appl. No.: 19/009,182

(22) Filed: Jan. 3, 2025

(30) Foreign Application Priority Data
Jan. 12, 2024 (KR) 10-2024-0005677

(51) Int. Cl. G01N 21/95; G01N 21/956; G01N 23/2251

(52) U.S. Cl. CPC G01N 21/9501; G01N 21/956; G01N 23/2251; G01N 2223/6116

(57) ABSTRACT

Provided is a wafer inspection method including obtaining raw data in an optical inspection process for a wafer, identifying data in the raw data corresponding to a plurality of evaluation areas, generating statistical information for first characteristics of each evaluation area of the plurality of evaluation areas from the raw data corresponding to the plurality of evaluation areas, selecting at least some of the evaluation areas as a selection area through a comparison of the statistical information of each of the evaluation histograms, selecting an inspection area including at least a portion of the selection area, and performing an electron beam (e-Beam) inspection on the inspection area.

### CROSS-REFERENCE TO RELATED APPLICATION

This application is based on and claims priority under 35 U.S.C. § 119 to Korean Patent Application No. 10-2024-0005677, filed on Jan. 12, 2024, in the Korean Intellectual Property Office, the disclosure of which is incorporated by reference herein in its entirety.

### BACKGROUND

The inventive concept relates to a wafer inspection method, and more particularly, to a wafer inspection method including electron beam inspection.

An optical inspection process is typically performed by estimating the presence or absence of defects on wafers by comparing an image with another image in units of pixels to evaluate the image or wafer inspection or by estimating the presence or absence of defects on wafers by comparing an image with a reference image to evaluate the image and checking the estimated defects through an electron beam. In an inspection method using an electron microscope, an inspection area per unit time is significantly smaller than optical inspection, and thus a small area of the entire wafer area may be inspected during a wafer production process, making it difficult to detect actual defects.

### SUMMARY

The inventive concept provides a wafer inspection method that improves the efficiency of electron beam inspection and detects wafer defects more efficiently.

The object of the inventive concept is not limited to the above description, and other objects not mentioned will be clearly understood by those skilled in the art from the description below.

According to an aspect of the inventive concept, there is provided a wafer inspection method including obtaining raw data in an optical inspection process for a wafer, identifying data in the raw data corresponding to a plurality of evaluation areas, generating statical information for first characteristics of each evaluation area of the plurality of evaluation areas from the raw data, selecting at least some of the evaluation areas as a selection area through a comparison of the statistical information of each of the evaluation areas, selecting an inspection area including at least a portion of the selection area, and performing an electron beam (e-Beam) inspection on the inspection area.

According to another aspect of the inventive concept, there is provided a wafer inspection method including obtaining raw data in an optical inspection process on a wafer, setting a plurality of evaluation areas for the wafer and identifying data in the raw data corresponding to the plurality of evaluation areas, generating statistical data for first characteristics of each evaluation area of the plurality of evaluation areas from the raw data, selecting at least some evaluation areas of the plurality of evaluation areas as a selection area through the statistical data, selecting an inspection area including at least some of the plurality of selection areas, and performing an electron beam (e-Beam) inspection on the inspection area, wherein the first characteristics include a gray level and a focus map, the selecting of the selection area includes selecting at least some of the plurality of evaluation areas as the selection area based on a characteristic evaluation reference for the first characteristics, the characteristic evaluation reference includes one or more of an average, a full width at half maximum (FWHM), a standard deviation, and a range, and the plurality of evaluation areas include at least one of an undiced chip, a functional block, a pattern area, or a local pattern in the plurality of undiced chips provided in the wafer, the plurality of functional blocks provided in the undiced chip, the plurality of pattern areas provided in the functional block, or the plurality of local patterns provided in the pattern area.

According to another aspect of the inventive concept, there is provided a wafer inspection method including obtaining raw data in an optical inspection process on a wafer, setting a plurality of evaluation areas and identifying data corresponding to the evaluation areas in the raw data, generating statistical data for first characteristics of each evaluation area of the plurality of evaluation areas from the raw data, selecting at least some evaluation areas of the plurality of evaluation areas as a selection area using the plurality of evaluation histograms, selecting an inspection area including at least a portion of the selection area, and performing an electron beam (e-Beam) inspection on the inspection area, wherein the setting of the plurality of evaluation areas includes obtaining positions of the plurality of evaluation areas from a design of the wafer, the first characteristics include a gray level and a focus map, the gray level represents reflectance in a first wavelength range, and the focus map represents a vertical level of patterns, the first wavelength range is selected as a wavelength range in which a difference in reflectance between patterns provided in the plurality of evaluation areas is greatest in an optical inspection apparatus that performs the optical inspection process, the first wavelength range being selected within 190 nm to 650 nm, the selecting of the selection area includes generating an evaluation chart based on a characteristic evaluation reference for the plurality of evaluation areas and selecting the selection area from the evaluation chart, the characteristic evaluation reference including one or more of an average, a full width at half maximum (FWHM), a standard deviation, or a range, and a type of the evaluation chart including a Pareto chart, in the evaluation chart, all of the evaluation areas with a rate corresponding to the top N % are selected as the selection area from among the plurality of evaluation areas, and some of high-level evaluation areas with a rate corresponding to between the top N % (where N is a real number between 1 and 50) and the top M % (where M is less than N and N is a real number between 1 and 100) is selected as the selection area from among the plurality of evaluation areas, the plurality of evaluation areas include at least one of an undiced chip, a functional block, a pattern area, or a local pattern in the plurality of undiced chips provided in the wafer, the plurality of functional blocks provided in the undiced chip, the plurality of pattern areas provided in the functional block, or the plurality of local patterns provided in the pattern area, the selecting of the inspection area includes calculating a density per unit area of the selection area on the wafer from a design of the wafer according to a position on the wafer and selecting a portion of the wafer with a high density of the selection area as the inspection area, and the performing of the e-Beam inspection includes performing the e-Beam inspection on the inspection area through the position of the inspection area obtained from the design, the inspection area including a portion of the wafer.

### BRIEF DESCRIPTION OF THE DRAWINGS

Embodiments will be more clearly understood from the following detailed description taken in conjunction with the accompanying drawings in which:

FIG. 1 is a flowchart for explaining a wafer inspection method according to an embodiment;

FIG. 2 is a diagram for explaining a wafer inspection method according to an embodiment;

FIG. 3 is a diagram for explaining a wafer inspection method according to an embodiment;

FIG. 4 is a diagram for explaining a wafer inspection method according to an embodiment;

FIG. 5 is a graph showing plots separately indicating reflectance that varies depending on a wavelength of light to be selected in the optical inspection process depending on a material that makes up a semiconductor substrate;

FIG. 6 is a diagram showing a process of generating and evaluating a histogram for each selected evaluation area;

FIG. 7 is a graph for explaining a wafer inspection method according to an embodiment;

FIG. 8 is a diagram for explaining a method of selecting an inspection area of a wafer inspection method according to an embodiment;

FIG. 9 is a block diagram illustrating a computer system implementing a wafer inspection method according to an embodiment; and

FIG. 10 is a block diagram illustrating a computer system and a computer readable medium that perform a wafer inspection method according to an embodiment.

### DETAILED DESCRIPTION OF THE EMBODIMENTS

Hereinafter, embodiments of the technical spirit of the inventive concept will be described in detail with reference to the attached drawings.

Examples of the technical spirit of the inventive concept are provided to more completely explain the technical spirit of the inventive concept to those skilled in the art, and the following examples may be modified into various other forms. The scope of the technical spirit of the inventive concept is not limited to the following examples. Rather, these embodiments are provided to make the inventive concept more faithful and complete and to completely convey the technical spirit of the inventive concept to those skilled in the art. In the drawings, the thicknesses of layers and regions are exaggerated for clarity.

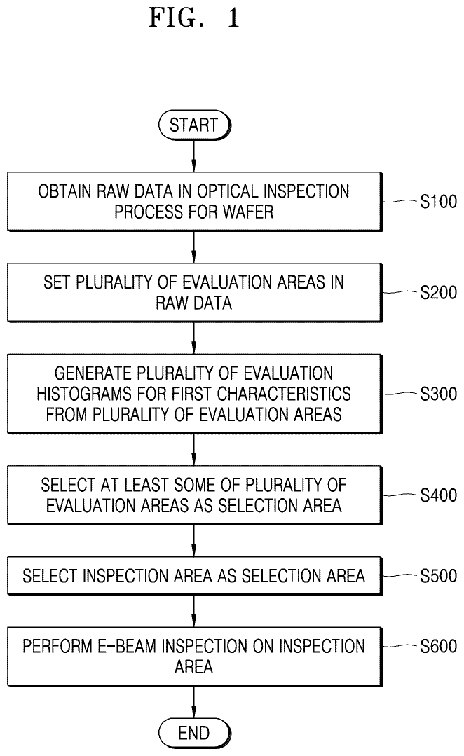

FIG. 1 is a flowchart for explaining a wafer inspection method 1 according to an embodiment.

Referring to FIG. 1, the wafer inspection method 1 may include obtaining raw data in an optical inspection process for a wafer (S100), setting a plurality of evaluation areas in the raw data (S200), generating a plurality of evaluation histograms for first characteristics from the plurality of evaluation areas (S300), selecting at least some of the plurality of evaluation areas as a selection area (S400), selecting an inspection area from the selection area (S500), and performing an electron beam inspection on the inspection area (S600). A detailed description of each operation is given below with reference to the drawings.

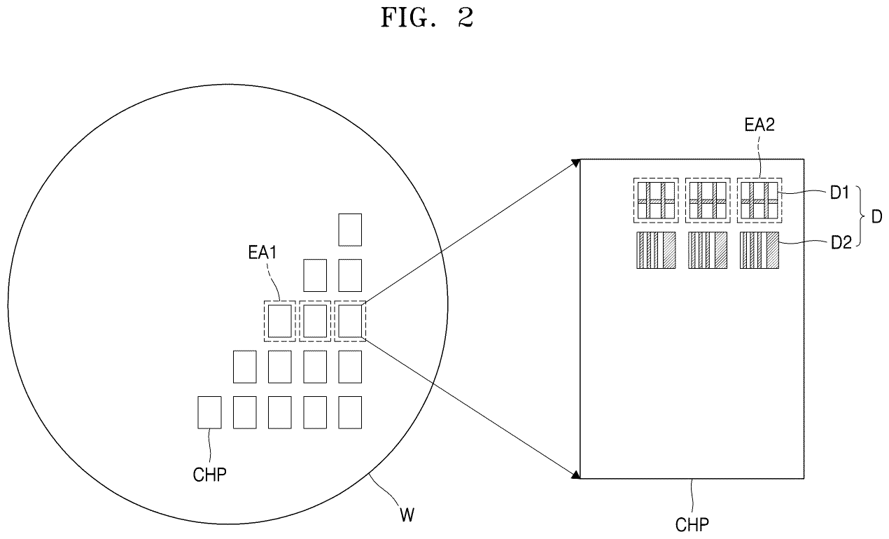

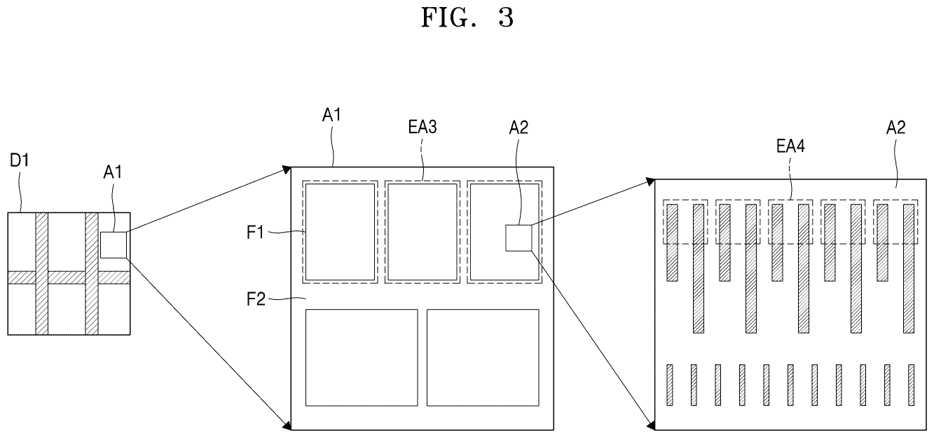

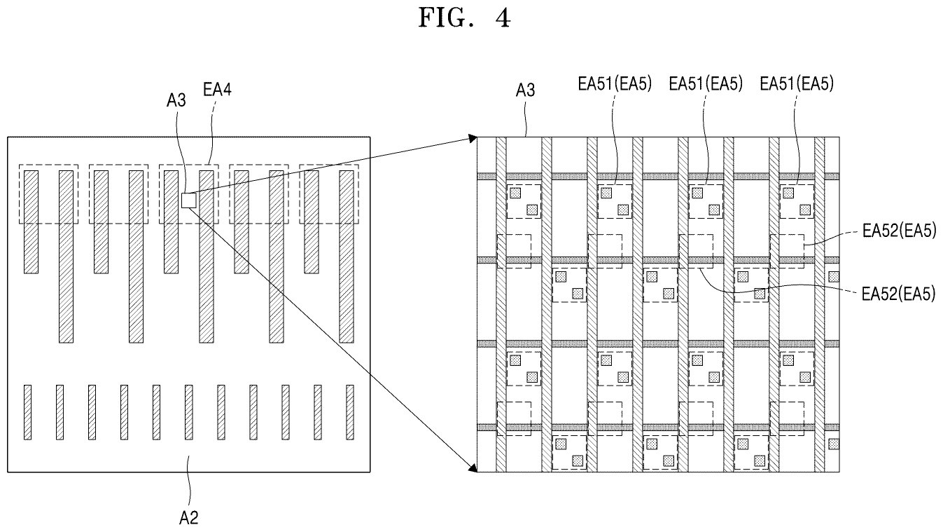

FIG. 2 is a diagram for explaining the wafer inspection method 1 according to an embodiment. FIG. 3 is a diagram for explaining the wafer inspection method 1 according to an embodiment. FIG. 4 is a diagram for explaining the wafer inspection method 1 according to an embodiment.

Referring to FIG. 2, optical inspection may be performed on a semiconductor substrate W. A certain pattern may be formed on the semiconductor substrate W, and a plurality of undiced chips, which are independently drivable units, may be provided. The semiconductor substrate W may be referred to as a wafer.

The semiconductor substrate W may include, for example, silicon (Si), such as crystalline Si, polycrystalline Si, or amorphous Si. Alternatively, the semiconductor substrate W may include a semiconductor element such as germanium (Ge) and at least one compound semiconductor selected from silicon germanium (SiGe), silicon carbide (SiC), gallium arsenide (GaAs), indium arsenide (InAs), and indium phosphide (InP). Alternatively, the semiconductor substrate W may have a silicon on insulator (SOI) structure. For example, the semiconductor substrate W may include a buried oxide (BOX) layer. The semiconductor substrate W may include a conductive region, for example, a well doped with impurities or a structure doped with impurities.

Raw data may be obtained in a process of optical inspection on the semiconductor substrate W. The raw data refers to unprocessed data obtained during the optical inspection process and may include raw inspection data. For example, the raw data of the semiconductor substrate W may be processed into a gray scale for a specific wavelength band and output as an image.

As shown in FIG. 2, a plurality of undiced chips CHP may be provided on the semiconductor substrate W. The semiconductor substrate W may be diced, cut, and/or singulated between the undiced chips to provide individual chips. At least one of the plurality of undiced chips CHP may be selected as a first evaluation area EA1. A detailed description of the use of the first evaluation area EA1 will be given below.

The undiced chip CHP may include a plurality of functional blocks D. The plurality of functional blocks D may collectively function as one undiced chip, and the functional block D may be a structural unit that performs a function for one undiced chip CHP. The functional block D may be referred to as a die block.

One or more different types of functional blocks D may be provided in the undiced chip CHP. For example, as shown in FIG. 2, three first functional blocks D1 may be provided in the undiced chip CHP, and three second functional blocks D2 may be provided in the undiced chip CHP. One or more different types of functional blocks D may be provided in the undiced chip CHP.

One or more of the plurality of functional blocks D of the undiced chip CHP may be selected as a second evaluation area EA2. The second evaluation area EA2 may be selected with the same type of functional blocks D. For example, as shown in FIG. 2, all of the first functional blocks D1 provided in the undiced chip CHP may each be selected as the second evaluation area EA2. A detailed description of the use of the second evaluation area EA2 will be given below.

Referring to FIG. 3, a first area A1, which is a portion of the first functional block D1, may include a first functional area F1 and a second functional area F2. The first area A1 may include and/or correspond to, for example, a memory semiconductor. The memory semiconductor may include, for example, a cell array area which may be the first functional area F1, and a peripheral circuit area which may be the second functional area F2.

For example, when the functional area is a portion of dynamic random access memory (DRAM), the first functional area F1 may include a cell array area and the second functional area F2 may include a peripheral circuit area. The cell array area may include a memory cell area of a DRAM device, and the peripheral circuit area may include a core area or peripheral circuit area of the DRAM device. For example, the cell array area may include a cell transistor and a capacitor structure connected thereto, and the peripheral circuit area may include a peripheral circuit transistor for transmitting a signal and/or power to the cell transistor provided in the cell array area.

In example embodiments, the peripheral circuit transistor may constitute various circuits such as a command decoder, a control logic, an address buffer, a row decoder, a column decoder, a sense amplifier, and a data input/output circuit. The examples of the first functional area F1 and the second functional area F2 are provided to aid understanding, and the inventive concept is not limited to this example.

The first functional area F1 may be selected as a third evaluation area EA3 from among the first functional area F1 and the second functional area F2 provided in the first area A1, which is a portion of the first functional block D1. Any of the first functional areas F1 provided in the first area A1 may be selected as the third evaluation area EA3. However, the first functional area F1 and the second functional area F2 may not be provided in the second functional block D2. A detailed description of the use of the third evaluation area EA3 will be given below.

A portion of the first functional area F1 provided in the first area A1 may include a pattern area. The pattern area may be an area in which repeated patterns are collectively observed as a single unit pattern. The pattern area may be distinguished from other surrounding patterns, and the pattern area may be repeatedly provided on the semiconductor substrate W. A portion of the first functional area F1 may be selected as the second area A2, and the second area A2 may include repeated pattern areas. In the pattern area, all repeated pattern areas may be provided in a fourth evaluation area EA4. That is, the plurality of pattern areas selected as the fourth evaluation area EA4 may be present in the undiced chip, the functional block, and the functional area. The pattern area selected as the fourth evaluation area EA4 may be provided in the first functional area F1 but not in the second functional area F2. A detailed description of the use of the fourth evaluation area EA4 will be given below.

A portion of the pattern area selected as the fourth evaluation area EA4 provided in the second area A2 may include local patterns. That is, a portion of the second area A2 may be selected as a third area A3, and the third area A3 may include local patterns. Some of the local patterns may be selected as a fifth evaluation area EA5. The local patterns may be patterns formed by the minimum units of structures constituting a semiconductor device.

For example, in FIG. 4, the third area A3 may include repeated patterns and local patterns that are repeated in the repeated pattern may be selected as the fifth evaluation area EA5. The positions of the first evaluation area EA1 to the fifth evaluation area EA5 may be obtained from the raw data obtained during the optical inspection of the semiconductor substrate W, or may be obtained by reading the corresponding positions from a design of the semiconductor substrate W.

Hereinafter, as an example, a process in which a selection area is selected through evaluation of first characteristics for the fifth evaluation area EA5 will be described.

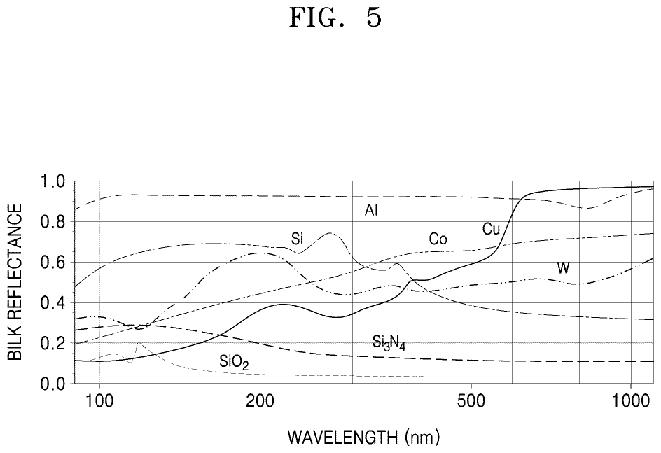

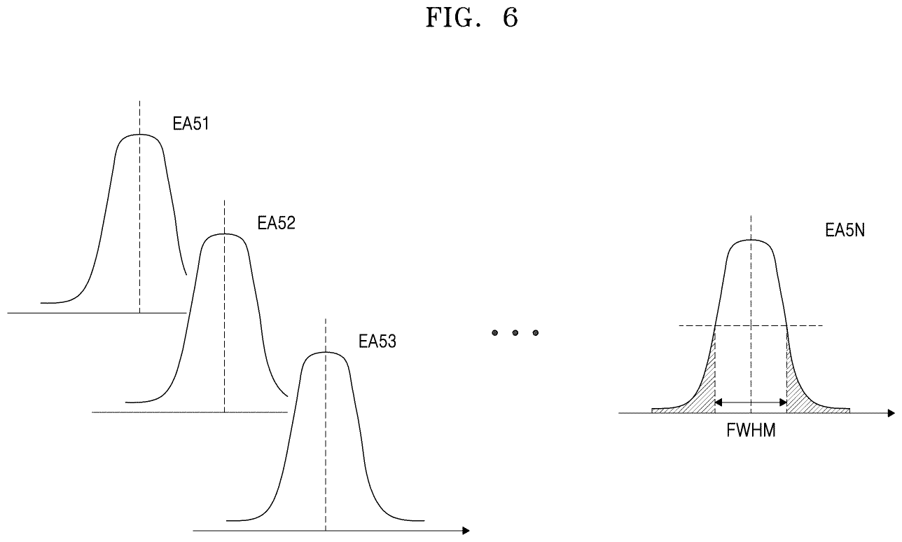

FIG. 5 is a graph showing plots indicating the reflectance of light depending on the wavelength of the light for different materials. The graph shows that the reflectance varies depending on a wavelength of the light in the optical inspection process and on the material that makes up a semiconductor substrate. FIG. 6 is a diagram showing a process of generating and evaluating a histogram for each selected evaluation area. The histogram may be referred to as an evaluation histogram.

Referring to FIGS. 5 and 6, various repeated local patterns may be selected as the fifth evaluation area EA5. For example, as shown in FIG. 4, a region or regions indicated by the dotted line may be selected as a 5^{th}-1 evaluation areas EA51. Likewise, other repeated regions may be selected as a 5^{th}-2 evaluation areas EA52 and a 5^{th}-3 evaluation areas EA53 to a 5^{th}-N evaluation areas EA5N. That is, the fifth evaluation area EA5 may include the 5^{th}-1 evaluation areas EA51 to the 5^{th}-N evaluation areas EA5N. Each of the 5^{th}-1 evaluation areas EA51 to the 5^{th}-N evaluation areas EA5N may be areas with a certain size including repeated local patterns. The 5^{th}-1 evaluation areas EA51 to the 5^{th}-N evaluation areas EA5N may each include areas set to approximately the same area.

For each of the 5^{th}-1 evaluation areas EA51 to the 5^{th}-N evaluation areas EA5N, a histogram may be created based on the first characteristics for the respective evaluation areas. The first characteristics may be measured based on an optical inspection of the evaluation areas. The first characteristics may include a gray scale (gray level) and a focus map. For example, in each of the 5^{th}-1 evaluation areas EA51, a gray level may be measured, and a histogram of the gray levels gray levels may be generated. A gray level value may be measured as one of the first characteristics of each of the 5^{th}-1 evaluation area EA51 to the 5^{th}-N evaluation area EA5N from the raw data of the semiconductor substrate W described above. In the present embodiment, each evaluation area (e.g., EA51) may appear repeatedly on the wafer. For instance, the same local pattern may be formed in hundreds or thousands of different locations. A gray level is measured for each repeated instance of that local pattern, thus collecting multiple gray level data points from all repeated EA51 patterns on the wafer. A histogram is then generated by plotting the frequency of these reflectance values for EA51. Therefore, the large number of repeated instances enables a histogram.

The gray level as one of the first characteristics may be data based on the reflectance of reflected light detected and/or obtained during optical inspection of the semiconductor substrate W. The focus map as one of the first characteristics is positional data recorded for positions on a wafer based on an adjustment of a focus to perform optical inspection on the semiconductor substrate W by an optical inspection apparatus. For example, the focus may be adjusted to focus at different vertical levels of the substrate during the optical inspection. In the process of performing the optical inspection on the semiconductor substrate W, a vertical level difference of a surface of the semiconductor substrate W may be obtained through the focus map, and thus information in the focus map may be substantially similar to or equivalent to information indicating a vertical level of the surface of the semiconductor substrate W. In this specification, the gray level that represents the reflectance of the semiconductor substrate W will be explained as an example.

The local patterns provided in each of the 5^{th}-1 evaluation areas EA51 to the 5^{th}-N evaluation areas EAN may be difficult to completely identify with the resolution of an optical device due to the recently developed miniaturization of semiconductors.

The local patterns provided in each of the 5^{th}-1 evaluation areas EA51 to the 5^{th}-N evaluation areas EA5N may include defects. For example, defects may include defects that occur when adjacent patterns are connected to each other or defects that occur when the middle of a pattern is short-circuited. These examples of defects are provided to aid understanding, and the defects that may occur are not limited to the above examples.

However, these defects may be difficult to identify by an optical inspection apparatus as described above, which may be due to limitations in resolution or due to a low signal to noise ratio (SNR). When a noise level is high due to process distribution and the like, even if an actual defect exists, an SNR for the actual defect may be less than 1 indicating that the noise is greater than the signal, and thus it may be difficult to detect this as a defect.

When a gray level value is calculated from the raw data obtained from the optical inspection of the semiconductor substrate W for the 5^{th}-1 evaluation areas EA51 to the 5^{th}-N evaluation areas EA5N, it may be difficult to directly detect defects in the local patterns provided in the fifth evaluation area EA5 through optical inspection, but the defects in the local patterns may affect the gray scale in each of the evaluation areas. For example, a defect may cause the reflectance to change for an evaluation area.

The gray scale for an evaluation area of the semiconductor substrate W, obtained through optical inspection, may be determined depending on the reflectance of a material constituting the semiconductor substrate W in the evaluation area in the optical inspection process of the semiconductor substrate W. Therefore, to better detect defects contained in the local patterns, a wavelength may be chosen that has a greater impact on the gray scale. The raw data may be obtained by selecting an appropriate wavelength range of light (e.g., a wavelength with the highest reflectivity for the material or a wavelength with the greatest difference in reflectivity for two materials of interest) and performing optical inspection of the semiconductor substrate W to increase a difference in reflectance of materials contained in the local patterns.

Main materials of the local patterns contained in the fifth evaluation area EA5 may include, for example, tungsten (W) and Si₃N₄. A difference in reflectance of materials may vary depending on the wavelength of light emitted during the optical inspection process of the semiconductor substrate W. For example, for a wavelength of light from about 100 nm to about 190 nm, the light reflectance of Si₃N₄ may be greater than that of W with respect to the same wavelength range. In contrast, for a wavelength of light of 190 nm or more, the light reflectance of W may be greater than that of Si₃N₄. As seen from the graph, a difference in reflectance between Si₃N₄ and W with respect to light having a wavelength in the range of 100 nm to 190 nm may be greater than a difference in reflectance between Si₃N₄ and W with respect to light having a wavelength of 190 nm or more. Thus, when the main materials of the local patterns are, for example, W and Si₃N₄, light having a wavelength in the range of 190 nm to 650 nm may be selected for the optical inspection and a gray scale for the wavelength range may be obtained.

The wavelength of the light may be selected depending on the materials and the present example depending on a difference in light reflectance between Si₃N₄ and W is merely an example to help understand the embodiments, and the inventive concept is not limited thereto.

As described above, for example, when the main materials of the local patterns provided in the fifth evaluation area EA5 are W and Si₃N₄, light having a wavelength in a range with a large difference in reflectance between W and Si₃N₄ may be selected to ensure that defects contained in the local patterns have a greater impact on the gray scale, and the wavelength of the light used for the optical inspection therefor may be in the range of 190 nm to 650 nm.

For the 5^{th}-1 evaluation areas EA51 to the 5^{th}-N evaluation areas EA5N, a histogram of gray scale for each evaluation area may be calculated/generated as shown in FIG. 6. Through statistical analysis of a gray scale for each of the 5^{th}-1 evaluation areas EA51 to the 5^{th}-N evaluation area EAN, a gray scale histogram of each of the 5^{th}-1 evaluation areas EA51 to the 5^{th}-N evaluation areas EA5N may be created.

For example, as shown in an upper-right end of the third area A3 in FIG. 4, a defect in which two square-shaped local patterns are connected to each other may occur in one of the plurality of 5^{th}-1 evaluation areas EA51. A gray level of a 5^{th}-1 evaluation area EA51 in which a defect occurs may be increased or decreased compared to the other 5^{th}-1 evaluation areas EA51. The gray scale histograms for the plurality of 5^{th}-1 evaluation area EA51 including a 5^{th}-1 evaluation area EA51 in which a defect occurs may have a different distribution than a gray scale histogram of the plurality of 5^{th}-1 evaluation areas EA51 having no defect.

For each grayscale histogram created for the 5^{th}-1 evaluation areas EA51 to the 5^{th}-N evaluation areas EA5N, each histogram may be evaluated through a characteristic evaluation reference. The characteristic evaluation reference may include one or more of a standard deviation, a range of values, a full width at half maximum (FWHM), or a central value. The characteristic evaluation reference may be based on an historic measurement, an average measurement for similar areas, or a known reference value. In this specification, the FWHM is described as the characteristic evaluation reference, but this is for case of understanding, and the inventive concept is not limited to the case in which the characteristic evaluation reference is the FWHM.

Each grayscale histogram created for the 5^{th}-1 evaluation areas EA51 to the 5^{th}-N evaluation areas EA5N may have a shape generally similar to that of the normal distribution. However, a histogram for an evaluation area containing relatively many defects may deviate from the normal distribution compared with a histogram for an evaluation area containing relatively few defects. Alternatively, a shape of the histogram for the evaluation area containing relatively many defects may be different from the histogram for the evaluation area with relatively few defects.

For example, an FWHM may be calculated for a grayscale histogram created for each of the 5^{th}-1 evaluation areas EA51 to the 5^{th}-N evaluation areas EASN. Assuming that the 5^{th}-1 evaluation areas EA51 contains relatively more defects that reduce or increase the gray scale, a rate of samples that fall outside the FWHM in the 5^{th}-1 evaluation areas EA51 may be greater than the other evaluation areas. That is, the 5^{th}-1 evaluation areas EA51 contains relatively many defects, and thus a rate of samples exceeding the FWHM in the 5^{th}-1 evaluation areas EA51 may be greater than the other evaluation areas.

In this specification, the characteristic evaluation reference is described in detail using an FWHM as an example, but those skilled in the art will understand that other values may also be the characteristic evaluation reference.

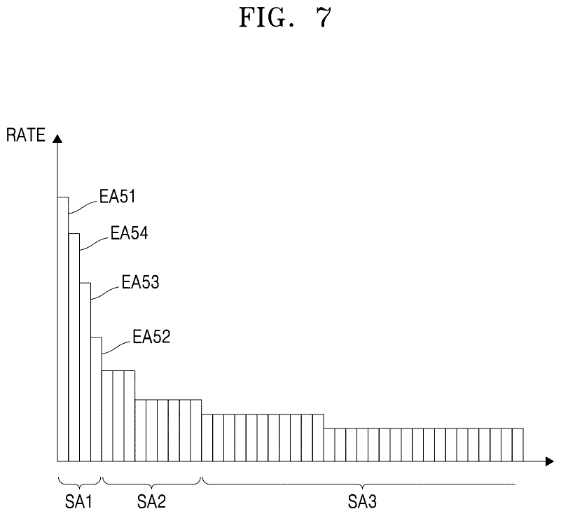

When an FWHM is the characteristic evaluation reference, as a rate of deviations from the FWHM in a histogram of an evaluation area is increased, a priority to be described below with reference to FIG. 7 may be set to be high.

When the standard deviation is the characteristic evaluation reference, as the rate of deviations of the standard deviation in a histogram of an evaluation area increases beyond a certain multiple of standard deviation for the evaluation area (e.g., an historic standard deviation for the evaluation area, an average standard deviation for similar evaluation areas, or a standard deviations for a reference substrate), a priority to be described below with reference to FIG. 7 may be set to be to high. In one example, the certain multiple may be 3 times. Additionally, the standard deviation derived from the histogram obtained from the measured wafer can also be used as the standard deviation for priority evaluation, since the ratio exceeding this multiple may vary depending on the distribution shape of the histogram (e.g., asymmetric or thick-tailed pattern).

When a range is the characteristic evaluation reference and the range of values of samples in a histogram of an evaluation area is larger than an average range (e.g., an historic average for the evaluation area, an average for similar evaluation areas, or an average for a reference substrate), a priority to be described below with reference to FIG. 7 may be set to be high. When a value other than the values mentioned above is the characteristic evaluation reference, those skilled in the art will understand a method of setting a priority based on the above description.

FIG. 7 is a graph for explaining the wafer inspection method 1 according to an embodiment.

Referring to FIG. 7, a histogram for the first characteristics may be created for the evaluation areas, and the histogram for the first characteristics may be evaluated based on the characteristic evaluation reference to calculate priorities for the evaluation areas.

For example, as described above, it may be assumed that the 5^{th}-1 evaluation area EA51 contains relatively many defects. As described above with reference to FIG. 6, the 5^{th}-1 evaluation area EA51 contains relatively many defects, and thus a rate of samples exceeding an FWHM may be relatively high in the 5^{th}-1 evaluation area EA51.

Evaluation areas of the fifth evaluation area EA5 evaluated based on the characteristic evaluation reference such as an FWHM may be shown in order of the rate of samples exceeding the FWHM. For example, as shown in FIG. 7, the results of evaluating the grayscale histogram for the fifth evaluation area EA5 based on the FWHM may be shown through an evaluation chart. One example of an evaluation chart is a Pareto chart.

As described above, when the 5^{th}-1 evaluation areas EA51 contains relatively many defects, a rate of samples that deviate from the FWHM in the 5^{th}-1 evaluation area EA51 is high, and thus a value for the 5^{th}-1 evaluation area EA51 may be shown as the leftmost bar plot in the Pareto chart of FIG. 7. In order of the highest rate of samples exceeding the FWHM, portions of the 5^{th}-1 evaluation area EA51, the 5^{th}-4 evaluation area EA54, and the 5^{th}-2 evaluation area EA52 are each shown in the Pareto chart. The respective rates of the other evaluation areas provided in the fifth evaluation area EA5 may also be shown in the Pareto chart. In FIG. 7, the shown order of the 5^{th}-1 evaluation area EA51, the 5^{th}-4 evaluation area EA54, the 5^{th}-3 evaluation area EA53, and the 5^{th}-2 evaluation area EA52 is merely an example.

High-level evaluation areas with a high rate may be selected as selection areas. For example, the 5^{th}-1 evaluation area EA51, the 5^{th}-4 evaluation area EA54, the 5^{th}-3 evaluation area EA53, and the 5^{th}-2 evaluation area EA52 may be selected as a first selection area SA1. Other evaluation areas shown after the four evaluation areas may be selected as a second selection area SA2 based on rate values. Likewise, the other evaluation areas may be selected as a third selection area SA3 based on rate values. Those skilled in the art will understand that there may be other fourth selection areas and that additional selection areas may be configured as needed.

A priority may be given to select a selection area from the evaluation areas by using the Pareto chart. To give priorities, at least some of the evaluation areas may be selected as selection areas based on a rate.

For example, 100 evaluation areas may be shown in order of rate on the Pareto chart. Unlike FIG. 7, for 100 evaluation areas, 10 evaluation areas corresponding to the top 10% may be selected as the first selection area SA1. 10 evaluation areas corresponding to the top 10% to the top 20% excluding the top 10% may be selected as a second selection area. 30 evaluation areas corresponding to the top 20% to the top 50% excluding the top 20% may be selected as a third selection area. 50 evaluation areas corresponding to the top 50% to the top 100% may not be designated as a selection area or may be selected as a fourth selection area.

The first selection area to the fourth selection area may be selected from among the evaluation areas with priorities given according to rates, and thus more precise electron beam inspection may be performed on the first selection area, and a degree by which electron beam inspection is performed may be reduced toward the second selection area to the fourth selection area.

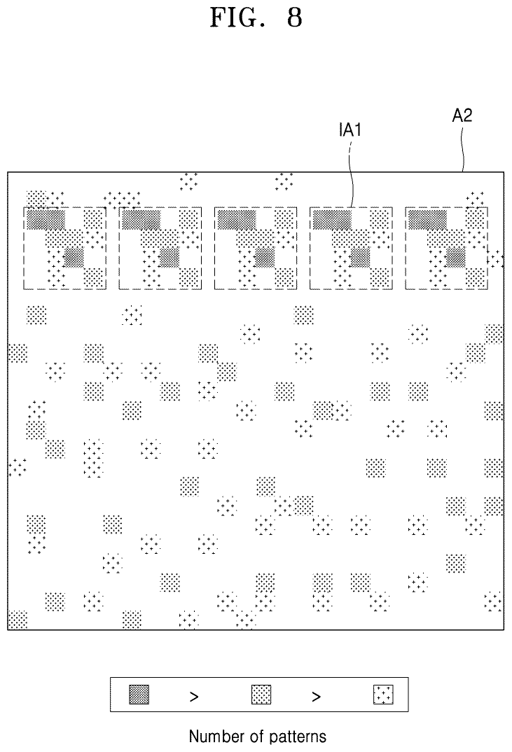

For example, when the 10 evaluation areas selected as the first selection area are set as the first inspection area through a process described below with reference to FIG. 8, electron beam inspection may be performed on the entire first inspection area.

When the 10 evaluation areas selected as the second selection area are set as the second inspection area through the process described below with reference to FIG. 8, an arbitrary rate, for example, half of the second inspection area may be extracted, and electron beam inspection may be performed thereon.

When the 30 evaluation areas selected as the third selection area are set as the third selection area through the process described below with reference to FIG. 8, a lower rate than that of the second inspection area, for example, 10% of the third inspection area may be extracted, and electron beam inspection may be performed thereon.

When the 50 evaluation areas selected as the fourth selection area are set as the fourth selection area through the process described below with reference to FIG. 8, a lower rate than that of the third inspection area may be extracted from the fourth inspection area and electron beam inspection may be performed thereon or electron beam inspection may not be performed on the fourth inspection area.

That is, the selection area is selected according to priority, the efficiency of the electron beam inspection may be further improved by performing the electron beam inspection starting from an inspection area containing a large number of high priority selection areas with respect to the inspection area formed from the selection area.

The rate and number of the evaluation areas selected as the selection area and a rate at which electron beam inspection is performed on the inspection area may be set differently depending on an inspection time, a defect type, a defect rate, an area of the inspection area, and the like.

FIG. 8 is a diagram for explaining a method of selecting an inspection area of the wafer inspection method 1 according to an embodiment.

Referring to FIG. 8, an inspection area may be selected from a selection area. The inspection area may be selected for an area in which many selection areas are distributed. The 5^{th}-1 evaluation area EA51 selected as the first selection area SA1, which is described above with respect to FIG. 7, will be described as an example.

The inspection area may be selected based on the selection area with respect to one type of an entire portion of the semiconductor substrate W, a partial portion of the semiconductor substrate W, an undiced chip provided in the semiconductor substrate W, a functional block provided in the undiced chip, a functional area provided in the functional block, and pattern areas provided in the functional area.

In some examples, a density per unit area of the 5^{th}-1 evaluation areas EA51 of some of the local patterns distributed in a second area shown in FIGS. 3 and 4 may be calculated depending on a position with respect to the 5^{th}-1 evaluation areas EA51. The density per unit area of the 5^{th}-1 evaluation areas EA51 may be calculated depending on the position by matching positions based on design data of the semiconductor substrate W.

An area with a high density of the local patterns may be selected as the inspection area by evaluating the density of the local patterns according to the position. As shown in FIG. 8, a portion of the high-density pattern area of the 5^{th}-1 evaluation area EA51 may be selected as the inspection area.

FIG. 8 shows that the number of the 5^{th}-1 evaluation areas EA51 contained in a certain unit area is calculated for a given area and the number of the 5^{th}-1 evaluation areas EA51 is shaded. The number per unit area may be referred to as density.

The 5^{th}-1 evaluation area EA51 may be formed throughout the semiconductor substrate W, may be formed on a certain undiced chip alone, may be formed on a certain functional block alone, or may be formed on a certain functional area alone. Therefore, an area based on which density is evaluated may vary depending on the selection area selected. In this specification, the case in which density is evaluated in units of areas such as the third area A3, which is a portion of the pattern area for the 5^{th}-1 evaluation area EA51, will be described as an example.

As shown in FIG. 8, the density within the second area A2 may be shown based on a unit area such as the third area A3. For example, the 5^{th}-1 evaluation areas EA51 may be more distributed in the fourth evaluation area EA4 than in the other areas. As such, an area in which a large number of the 5^{th}-1 evaluation areas EA51 selected as the first selection area SAL are distributed may be selected as a first inspection area IA1. As such, an area in which a relatively large number of the 5^{th}-4 evaluation areas EA54, the 5^{th}-3 evaluation areas EA53, and the 5^{th}-2 evaluation areas EA52 that are selected as the first selection area SA1 described above are distributed may be selected and each of the selected evaluation areas may be selected as an inspection area. That is, a portion of the semiconductor substrate W with a high density of the selection area may be preferentially selected and selected as the inspection area.

Unlike in FIG. 8, when the distribution of the first selection areas SA1 for the undiced chip CHP of FIG. 2 is evaluated, if a large number of the first selection areas SA1 are distributed in the first functional blocks D1, the first functional blocks D1 may be selected as the selection area.

When distribution of the first selection area SA1 for the first area A1 of FIG. 3 is evaluated, if a large number of the first selection areas SA1 are distributed in the first functional area F1, the first functional area F1 may be selected as the inspection area.

Once selected as the inspection area, an electron microscope may perform electron beam inspection on the selected inspection area. While the inspection area is selected, simultaneously, the position and area of the inspection area may be specified based on a design of the semiconductor substrate W and the electron microscope may perform electron beam inspection on the inspection area.

Electron beam inspection using an electron microscope requires a much greater inspection time than an optical inspection apparatus for the same area. For example, electron beam inspection for the same area may take about 10 times to about 100 times or more time than optical inspection. Therefore, it is substantially difficult to inspect the entire semiconductor substrate through electron beam inspection, and electron beam inspection is usually limited to checking defects in areas estimated to be defects through optical inspection.

The wafer inspection method 1 according to an embodiment may be distinguished from a normal case in which the presence or absence of defects is assumed by comparing images in units of pixels and evaluating the images in an optical inspection process on an area containing defects or the presence or absence of defects is assumed by comparing an image obtained in the optical inspection process with another reference image and evaluating the image and the estimated defects are checked through an electron beam.

The wafer inspection method 1 according to an embodiment is a method in which an area is selected, the first characteristics are evaluated in units of the areas, an area with a high priority is selected, a density of inspection on an area is adjusted depending on a priority of the area, and electron beam inspection is intensively performed on an area with relatively high priority.

Therefore, in the wafer inspection method 1 according to an embodiment, a priority may be set for a certain area based on data of optical inspection and electron beam inspection may be performed, and thus the electron beam inspection may be performed more efficiently.

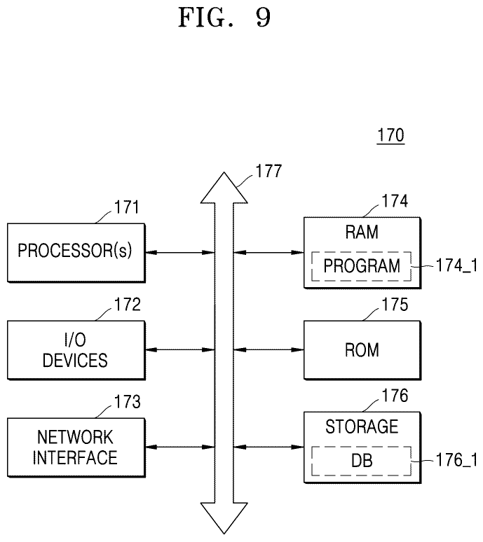

FIG. 9 is a block diagram illustrating a computer system 170 implementing the wafer inspection method 1 according to an embodiment.

Referring to FIG. 9, the wafer inspection method 1 described with reference to FIGS. 1 to 8 may be performed and implemented by the computer system 170.

The computer system 170 may include at least one computing apparatus. The computing apparatus may be a stationary apparatus such as a desktop computer, a workstation, or a server or may be a portable apparatus such as a laptop computer, a tablet, or a smartphone.

The computer system 170 may include a processor 171, input/output devices 172, a network interface 173, random access memory (RAM) 174, read only memory (ROM) 175, and a storage device 176. The processor 171, the input/output devices 172, the network interface 173, the RAM 174, the ROM 175, and the storage device 176 may be connected to a bus 177 and communicate with each other through the bus 177.

The processor 171 may be referred to as a processing unit and may, for example, include at least one core for executing any instruction set (e.g., Intel arthitecture-32 (IA-32), 64-bit extension IA-32, x86-64, PowerPC, Sparc, MIPS, ARM, or IA-64), like in a micro-processor, an application processor (AP), a digital signal processor (DSP), or a graphic processing unit (GPU). For example, the processor 171 may access a memory, that is, the RAM 174 or the ROM 175, through the bus 177 and execute instructions stored in the RAM 174 or the ROM 175.

The RAM 174 may store a program 174_1 for wafer inspection or at least a portion thereof, and the program 174_1 for wafer inspection may cause the processor 171 to perform the wafer inspection method. That is, the program 174_1 may include a plurality of instructions executable by the processor 171, and the plurality of instructions provided in the program 174_1 may cause the processor 171 to perform the wafer inspection method.

The stored data may not be lost from the storage device 176 even if power supplied to the computer system 170 is shut off. For example, the storage device 176 may include a non-volatile memory device, or may include a storage medium such as a magnetic tape, an optical disk, or a magnetic disk. The storage device 176 may be removable from the computer system 170. The storage device 176 may store the program 174_1 according to an embodiment, and the program 174_1 or at least a portion thereof may be loaded into the RAM 174 from the storage device 176 before the program 174_1 is executed by the processor 171. Alternatively, the storage device 176 may store a file written in a program language, and the program 174_1 generated by a compiler or the like from the file or at least a portion thereof may be loaded into the RAM 174. As shown in FIG. 5, the storage device 176 may store a database 176_1, and the database 176_1 may include data required for wafer inspection.

The storage device 176 may store data to be processed by the processor 171 or data processed by the processor 171. That is, the processor 171 may generate data by processing data stored in the storage device 176 according to the program 174_1, and may store the generated data in the storage device 176.

The input/output devices 172 may include an input device such as a keyboard or a pointing device and may include an output device such as a display device or a printer. For example, a user may trigger execution of the program 174_1 by the processor 171 and check the result data through the input/output devices 172.

The network interface 173 may provide access to a network outside the computer system 170. For example, the network may include multiple computing systems and communication links, which may include wired links, optical links, wireless links, or any other type of links.

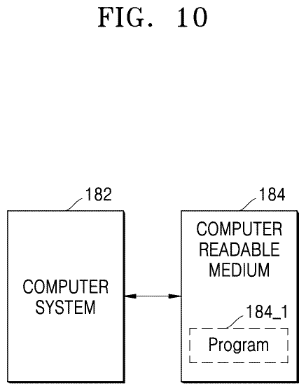

FIG. 10 is a block diagram illustrating a computer system 182 and a computer readable medium 184 that perform the wafer inspection method 1 according to an embodiment.

At least some of operations of the wafer inspection method 1 described above with reference to FIGS. 1 to 8 may be performed by the computer system 182. The computer system 182 may access the computer readable medium 184 and execute a program 184_1 stored in the computer readable medium 184. In some embodiments, the computer system 182 and the computer readable medium 184 may be collectively referred to as a wafer inspection apparatus.

The computer readable medium 184 may include a non-volatile memory device, similar to the storage device 176 of FIG. 9, or may include a storage medium such as a magnetic tape, an optical disk, or a magnetic disk. The computer readable medium 184 may be removable from the computer system 182.

Although the embodiments have been described with reference to the attached drawings, those skilled in the art will understand that the inventive concept may be modified into other detailed forms without changing the technical idea or necessary aspects. Therefore, the embodiments described above are exemplary in all respects and need should not be understood as limiting.

While the inventive concept has been particularly shown and described with reference to embodiments thereof, it will be understood that various changes in form and details may be made therein without departing from the spirit and scope of the following claims.

What is claimed is:

1. A wafer inspection method comprising:
obtaining raw data in an optical inspection process for a wafer;
identifying data in the raw data corresponding to a plurality of evaluation areas;
generating statistical information for first characteristics of each evaluation area of the plurality of evaluation areas from the data in the raw data corresponding to the plurality of evaluation areas;
selecting at least some of the evaluation areas as a selection area through a comparison of the statistical information of each of the evaluation areas;
selecting an inspection area including at least a portion of the selection area; and
performing an electron beam (e-Beam) inspection on the inspection area to identify defects in the inspection area.

2. The wafer inspection method of claim 1, wherein
the identifying of the plurality of evaluation areas includes obtaining positions of the plurality of evaluation areas from a design of the wafer.

3. The wafer inspection method of claim 1, wherein
the first characteristics include a gray level and a focus map.

4. The wafer inspection method of claim 3, wherein
the gray level represents reflectance in a first range of wavelengths, and
the focus map represents a vertical level of patterns.

5. The wafer inspection method of claim 4, wherein
the first range of wavelengths is selected as a range of wavelengths in which a difference in reflectance between patterns provided in the plurality of evaluation areas is maximized in an optical inspection apparatus that performs the optical inspection process.

6. The wafer inspection method of claim 5, wherein
the first range of wavelengths is selected to be within 190 nm to 650 nm.

7. The wafer inspection method of claim 1, wherein
the selecting of the selection area includes selecting at least some of the plurality of evaluation areas as the selection area based on a characteristic evaluation reference for the first characteristics, and
the characteristic evaluation reference includes one or more of an average, a full width at half maximum (FWHM), a standard deviation, or a range.

8. The wafer inspection method of claim 7, wherein
the selecting of the selection area includes prioritizing the evaluation areas based on the characteristic evaluation reference for the plurality of evaluation areas and selecting the selection area from the prioritized evaluation areas, and
presenting the prioritized evaluation areas as a Pareto chart.

9. The wafer inspection method of claim 8, wherein
in the prioritized evaluation areas, all of the evaluation areas with a rate corresponding to the top N % are selected as the selection area from among the plurality of evaluation areas, and
some of the evaluation areas with a rate corresponding to the lower (100-N) % are selected as the selection area from among the plurality of evaluation areas (where N is a real number between 1 and 100).

10. The wafer inspection method of claim 8, wherein
in the prioritized evaluation areas, all of the evaluation areas with a rate corresponding to the top N % are selected as the selection area from among the plurality of evaluation areas, and
some of high-level evaluation areas with a rate corresponding to between the top N % to the top M % are selected as the selection area from among the plurality of evaluation areas (where N is less than M, and N and M are real numbers between 1 and 100).

11. The wafer inspection method of claim 10, wherein
the evaluation areas with a rate corresponding to between the top M % to the 100% are not selected as the selection area from among the plurality of evaluation areas (where N is less than M, and N and M are real numbers between 1 and 100).

12. The wafer inspection method of claim 1, wherein
the plurality of evaluation areas includes at least one undiced chip of a plurality of undiced chips provided in the wafer, a plurality of functional blocks provided in each of the undiced chips, a plurality of pattern areas provided in each of the functional blocks, or a plurality of local patterns provided in each of the pattern areas.

13. The wafer inspection method of claim 12, wherein
the selecting of the inspection area includes calculating a density of the selection area on the wafer and selecting a portion of the wafer with a high density of the selection area as the inspection area.

14. The wafer inspection method of claim 13, wherein
the selecting of the inspection area includes one of selecting a pattern or functional block with a high density of the selection area on the wafer as the inspection area,
selecting a functional block or undiced chip with a high density of the selection area on the wafer as the inspection area, or
selecting a portion of an undiced chip or a portion of a wafer with a high density of the selection area on the wafer as the wafer inspection.

15. The wafer inspection method of claim 13, wherein
the selecting of the inspection area includes:
calculating a density per unit area of the selection area on the wafer from a design of the wafer according to a position on the wafer;
selecting at least a portion of the wafer with a high density of the selection area as the inspection area; and
obtaining a position of the inspection area from a design of the wafer.

16. The wafer inspection method of claim 15, wherein
the performing of the e-Beam inspection includes performing the e-Beam inspection on the inspection area through the position of the inspection area obtained from the design, and
the inspection area includes a portion of the wafer.

17. A wafer inspection method comprising:
obtaining raw data in an optical inspection process on a wafer;
setting a plurality of evaluation areas for the wafer and identifying data corresponding in the raw data corresponding to the plurality of evaluation areas;
generating statistical data for first characteristics of each evaluation area of the plurality of evaluation areas from the raw data;
selecting at least some evaluation areas of the plurality of evaluation areas as a selection area through the statistical data;
selecting an inspection area including at least some of the selection area; and
performing an electron beam (e-Beam) inspection on the inspection area,
wherein the first characteristics include a gray level and a focus map,
the selecting of the selection area includes selecting at least some of the plurality of evaluation areas as the selection area based on a characteristic evaluation reference for the first characteristics,
the characteristic evaluation reference includes one or more of an average, a full width at half maximum (FWHM), a standard deviation, and a range, and
the plurality of evaluation areas includes at least one of an undiced chip, a functional block, a pattern area, or a local pattern in a plurality of undiced chips provided in the wafer, a plurality of functional blocks provided in the undiced chip, a plurality of pattern areas provided in the functional block, or a plurality of local patterns provided in the pattern area.

18. The wafer inspection method of claim 17, wherein
the setting of the plurality of evaluation areas includes obtaining positions of the plurality of evaluation areas from a design of the wafer,
the gray level represents reflectance in a first wavelength range and the focus map represents a vertical level of patterns,
the selecting of the selection area includes generating an evaluation chart based on the characteristic evaluation reference for the plurality of evaluation areas and selecting the selection area from the evaluation chart, and
the selecting of the inspection area includes calculating a density of the selection area on the wafer and selecting a portion of the wafer with a higher density of the selection area as the inspection area relative to other portions of the wafer.

19. The wafer inspection method of claim 18, wherein
the selecting of the inspection area includes:
calculating a density per unit area of the selection area on the wafer from a design of the wafer according to a position on the wafer; and
selecting at least a portion of the wafer with a high density of the selection area as the inspection area and obtaining a position of the inspection area from a design of the wafer, and
the performing of the e-Beam inspection includes performing the e-Beam inspection on the inspection area through the position of the inspection area obtained from the design, the inspection area including a portion of the wafer.

20. A wafer inspection method comprising:
obtaining raw data in an optical inspection process on a wafer;
setting a plurality of evaluation areas and identifying data corresponding to the evaluation areas in the raw data;
generating statistical data for first characteristics of each evaluation area of the plurality of evaluation areas from the raw data;
selecting at least some evaluation areas of the plurality of evaluation areas as a selection area using the statistical data;
selecting an inspection area including at least a portion of the selection area; and
performing an electron beam (e-Beam) inspection on the inspection area,
wherein the setting of the plurality of evaluation areas includes obtaining positions of the plurality of evaluation areas from a design of the wafer,
the first characteristics include a gray level and a focus map, the gray level represents reflectance in a first wavelength range, and the focus map represents a vertical level of patterns,
the first wavelength range is selected as a wavelength range in which a difference in reflectance between patterns provided in the plurality of evaluation areas is greatest in an optical inspection apparatus that performs the optical inspection process, the first wavelength range being selected to be within 190 nm to 650 nm,
the selecting of the selection area includes generating an evaluation chart based on a characteristic evaluation reference for the plurality of evaluation areas and selecting the selection area from the evaluation chart, the characteristic evaluation reference including one or more of an average, a full width at half maximum (FWHM), a standard deviation, and a range, and a type of the evaluation chart including a Pareto chart,
in the evaluation chart, all of the evaluation areas with a rate corresponding to the top N % are selected as the selection area from among the plurality of evaluation areas, and some of high-level evaluation areas with a rate corresponding to between the top N % (where N is a real number between 1 and 50) and the top M % (where M is less than N and N is a real number between 1 and 100) is selected as the selection area from among the plurality of evaluation areas,
the plurality of evaluation areas includes at least one of an undiced chip, a functional block, a pattern area, or a local pattern in a plurality of undiced chips provided in the wafer, a plurality of functional blocks provided in the undiced chip, a plurality of pattern areas provided in the functional block, or a plurality of local patterns provided in the pattern area,
the selecting of the inspection area includes calculating a density per unit area of the selection area on the wafer from a design of the wafer according to a position on the wafer and selecting a portion of the wafer with a high density of the selection area as the inspection area, and
the performing of the e-Beam inspection includes performing the e-Beam inspection on the inspection area through the position of the inspection area obtained from the design, the inspection area including a portion of the wafer.
